(19) United States
(12) Patent Application Publication
(10) Pub. No.: US 2008/0154641 A1
(43) Pub. Date: Jun. 26, 2008

(54) Method for improving healthcare performance statistics

(75) Inventor: Paul F. Rulison, Troy, NY (US)

Correspondence Address: PAUL RULISON;TREO SOLUTIONS, 125 DEFREEST DRIVE, TROY, NY, 12180, US

(73) Assignee: Paul Rulison

(21) Appl. No.: 12/002,897

(22) Filed: Dec. 19, 2007

Related U.S. Application Data
(60) Provisional application No. 60/876,475, filed on Dec. 22, 2006.

(51) Int. Cl. G06Q 50/00

(52) U.S. Cl. 705/2

(57) ABSTRACT

A method of enhancing the quality of medical care reporting is disclosed. In general, statistical data regarding medical procedures is gathered and organized into desired categories (e.g. mortality, length of stay, etc.). The data is then analyzed to determine exceptional cases which the healthcare provider should afford further review to ensure the information was accurately and completely recorded at the time the care was provided. In using this data, healthcare professionals are able to make note of inconsistencies in the coding and description of cases that may result in an inaccurate reflection of the severity of a particular case. Using the exception report tools, healthcare providers can determine deficiencies in the file history notation process, and ultimately correct these deficiencies to arrive at a more accurate recording system.

### RELATED APPLICATION

This application claims priority to U.S. Provisional Ser. No. 60/876,475 filed Dec. 22, 2006, the contents of which are expressly incorporated herein by reference.

### BACKGROUND

In the healthcare industry, an increased focus on quality and performance improvement has necessitated the development of tools that can accurately and meaningfully monitor this type of information. To date, the data that has been used to measure hospital and physician quality has been garnered from a variety of resources and manipulated into indicators that attempt to shed light on providers' performance. In the case of New York, a commonly used dataset to create these types of indicators is the Statewide Planning and Research Cooperative System (SPARCS) database, which was developed in 1979 as a means of collecting hospital discharge information. SPARCS has since expanded its data collection efforts, and currently collects patient-specific information for every hospital discharge, ambulatory surgery patient, and emergency department admission in New York State.¹ However, since this information was never originally intended to measure provider performance, there was never a major incentive on the part of the providers to make sure that this information was highly accurate. This is not to say that efforts were not made to ensure data integrity, but rather that a sense of urgency was lacking since the information providers were submitting was not expected to be used for quality reporting or reimbursement purposes. The result is that any initial reporting efforts that were conceived using this data may depict a lesser quality of care than was truly provided by the institution or physician in question. This is a problem faced by states and providers around the country. ¹New York State Department of Health website. http://www.health.state.ny.us/statistics/sparcs/operations/overview.htm

Now that this information is being widely used by a multitude of entities to measure hospital and physician performance, the importance of the accuracy of the data is paramount. As CMS and private payers begin to consider payment methodologies that consider quality as one of the factors that play into provider reimbursement, hospitals and physicians are at risk for lower payments if their data does not represent the true quality of care provided. Monitoring provider performance without acknowledging the fact that these data issues exist may lead to unfair redistribution of provider reimbursements. Providers, therefore, require a means of ensuring their respective data is as clean and accurate as possible before it is released into the public forum. Furthermore, providers need access to this information via easily-understood and timely reports in order to track their own performance and progress over time.

Prior data systems have merely analyzed the data and provided hospitals and caregivers with numbers associated with the raw data without taking into account the many other factors that can and/or do cause the data to be inaccurate. In this increasingly competitive healthcare environment in which the focus on measuring performance is only continuing to increase, it is crucial that resources are made available not only to ensure the integrity of publicly-available data, but also to help providers monitor their own performance through the availability of meaningful and actionable information. Through the creation of Exception Reports, there has been developed a product that accomplishes both of these goals.

### SUMMARY

The present invention, referred to throughout this document as “Exception Reports”, uses publicly-available healthcare data or a hospital's own data to create a series of reports that flag various “exceptions” in the delivery of care. These reports allow healthcare providers (e.g. hospitals) to select predetermined threshold values to flag cases for further review. Additionally, this invention further affords providers the necessary diagnostic feedback to allow them to better organize their clinical and/or administrative protocols to yield numbers that are not only more accurate, but also more favorably reflect provider s' performance. Focusing solely on improving clinical protocols will not be enough, as negative reported outcomes are not always the result of inadequate clinical care. Incomplete documentation or coding can also result in reported data that does not truly represent the level of care provided by a hospital or physician. Therefore, using the Exception Reports to identify and address both clinical and administrative issues will ensure that the vast majority of factors that could potentially lead to data inaccuracies are accounted for. Lastly, because the information provided via these reports is recent and actionable, it can quickly be reviewed and possibly corrected for quality reporting and pay-for-performance initiatives, further ensuring the integrity of the publicly-available data.

The foundation of the Exception Reports is a computer system that has the necessary hardware to store and analyze the data, as well as the apposite algorithms to allow for the isolation of specific cases from the entire data set based on predetermined sensitivity levels. The data is collected directly from hospital clients on a monthly or quarterly basis. Once the data is received, it is run through the 3M Core Grouping Software, which risk-adjusts the data as appropriate on behalf of each hospital client. Specifically, it classifies the cases into various All-Patient Refined Diagnosis Related Groups (APR-DRGs), which is a patient classification system that groups similar types of patients together, accounting for severity of illness and risk of mortality. The primary reason for severity adjustment is to remove the long-standing and valid criticism that evaluative comparisons of two or more disparate groups based on observed data is often not an effective methodology due to differences in case mix between the groups under study. By using risk-adjusted data, physician s' arguments that “my patients are sicker” are no longer valid.

The resulting data is entered into a web-based platform and compiled into a package of electronic and hard copy reports. While new Exception Reports continue to be developed, the existing set includes reports covering the areas of:
Mortality;
High costs;
Long stays;
One day and ambulatory sensitive condition stays;
Admissions from nursing homes,;
ICU/CCU cases;
AHRQ Patient Safety Indicators; and
Hospital Quality—cases involving mortality and/or complications.

### The level of detail provided is dependent on the type of report produced and the data available, but includes case-level detail by APR-DRG, as well as information by physician, whenever possible.

The Exception Reports are run and distributed on a monthly or quarterly basis to hospital clients. Currently, they are disseminated electronically, via email, but can also be made available online through a secure web connection, in the form of paper reports, or placed as a file on a disk or CD. Possible issues highlighted by the reports include the following:
Documentation and/or coding did not fully reflect the complexity and hence the expected outcomes, cost and quality of the case;
Individual physician performance issues;
Hospital practice performance issues; and/or
Community practice performance issues.
   By using readily available, recent data and organizing it in this fashion, providers have a means with which to reflect upon and upgrade their quality of care provided to their patients, as well as to improve upon their current methods of documentation and coding. The reports themselves are used to help facilitate ongoing discussions among hospital leaders, medical records staff, quality staff and physicians. By narrowing the scope of cases via the predetermined algorithms, providers can concentrate specifically on cases that are true outliers, rather than focusing valuable time and energy on less important issues. Once the exceptions are identified on the reports, further investigation into specific cases is required to determine if clinical or administrative issues truly exist. Depending on the source of the problem, corrective action can be taken as appropriate. Administrative issues such as inadequate documentation and/or coding can be addressed through additional training and education of both the coding staff and physicians. Clinical issues must be addressed in a manner conducive to the situation.

This invention affords providers the benefit of not only increasing the accuracy of their statistics, but also of representing the hospital as well as the medical staff in the most favorable and fair way possible. Timely and organized access to this information is instrumental in ensuring that issues with data integrity are corrected quickly and in such a manner that minimizes any harm to the provider.

More importantly, our data services provide valuable filters that target specific cases as performance outliers. Hospital staff can focus on these cases to improve performance and health outcomes. In a world where healthcare providers are bombarded by data and information, the exception reports organize this data so as to provide value in enhancing operational decision-making and clinical performance. Without these unique filters (exception reports), providers are relegated to a cluttered data world; a world that is unorganized and not capable of driving change.

### BRIEF DESCRIPTION OF DRAWING

FIG. 1 is a flow diagram showing the steps used to generate exception reports.

FIG. 2 is an exemplary Exception Report.

### DETAILED DESCRIPTION

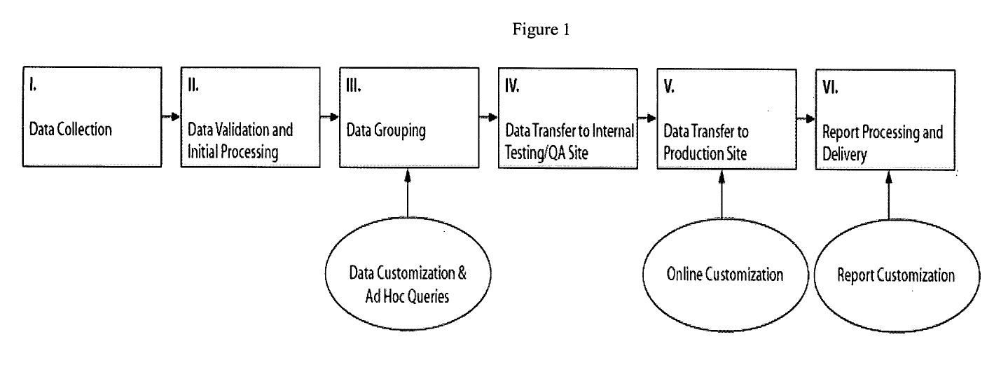

This description provides a detailed overview of the necessary steps that need to be taken from initial data collection to the monthly/quarterly distribution of Exception Reports for any client. Each stage is broken into specific steps, which highlight the Specific actions executed. FIG. 1 shows these steps in the form of a flowchart.
I. Data Collection: a client's monthly or quarterly data is collected through the necessary channels, such as SPARCS or from client provided statistics, and saved to the appropriate locations, and prepared for processing.
II. Data Validation and Initial Processing: A provider's data is run through a series of manual and automated data validation checks, while documenting any changes in the data file. Once the file has been validated and checked for quality, a program is run which appends the data file to the combined data file.
III. Data Grouping: Once the Combined data file has been checked for quality, the data is run through 3M™ grouper software creating a Grouper data Master file. After performing and documenting a quality assurance check on the Grouper Master Data file, the Grouper Master Data file is run through an SQL query, which splits the Grouper Master Data file into manageable datasets. Once these manageable datasets have been checked and documented for quality, Exception Reports can be processed for clients.
IV. Data Transfer to External Stage: At this point, the data is transferred to External Stage (the offsite server). After the data has been successfully transferred to External Stage, any differences in the Internal Stage data to the External Stage data is compared and documented to ensure data quality.
V. Production: Once the External Stage data is ready for production, it is posted to Production, which is viewable by all clients via on-line, web access. The Production data is reviewed to ensure that the most recent data is viewable and Reports are running correctly for each client.
VI. Exception Reports: After the data has been checked for quality on Internal Stage, Exception Reports are run for all clients who have submitted their data. Copies of the Exception Reports are printed and checked for quality, then e-mailed to clients. Follow-up analyses of Exception Report trends are performed and may, for example, be e-mailed to each client within 2 weeks of the initial reports distribution. Specific filter levels (e.g. 5% or 10%) are designated for flagging specific cases that fall outside a designated level for review, such as mortality rate. It is noted that this filter for denoting outlier cases may be set at any desired level, and the 5% filter used in the following example is merely a suggested value.

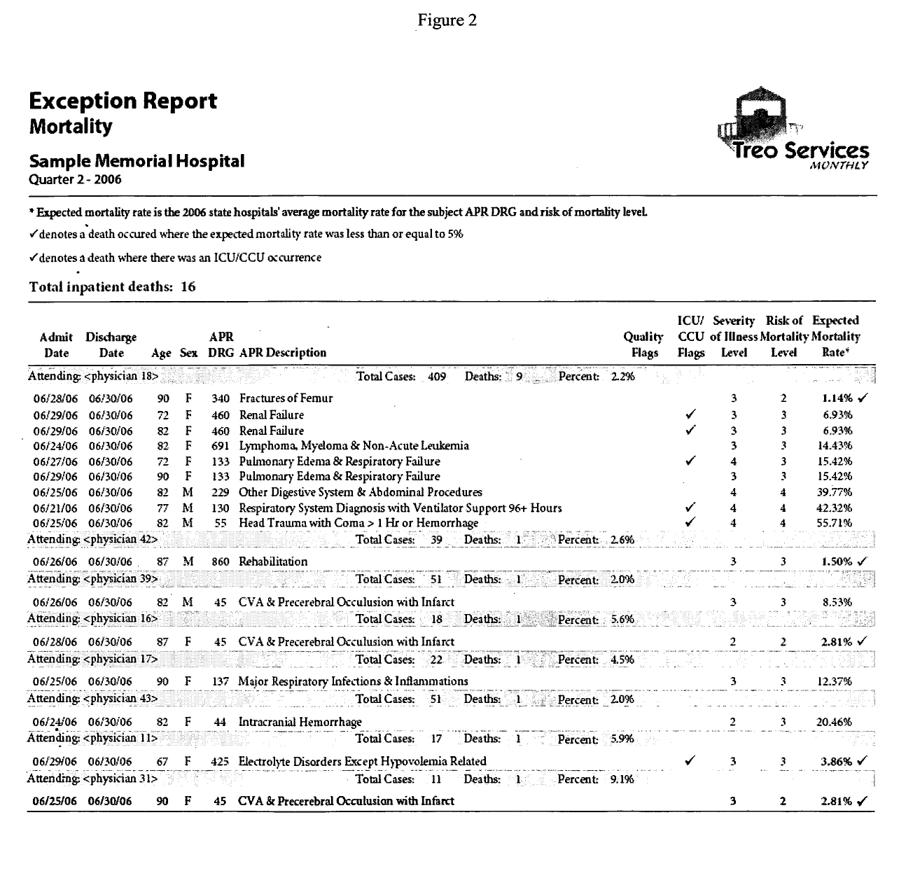

FIG. 2 shows a Mortality Exception Report as an example of the reports generated and disseminated to clients. The data contained in the report is sorted by physician and includes patient specific demographic information and APR-DRG diagnostic information. Each case is assigned a severity of illness and risk of mortality using the 3M grouper software. This report uses a statewide expected mortality benchmark to flag cases and prioritize for internal chart review. A filter of 5% is used to identify outlying cases. That is, the data highlights for review those cases where a patient has expired when there was a 95% chance of survival based on acquired statistics.

While regrettable, very sick individuals admitted to hospitals are likely to die while being treated. This report highlights that the expected mortality rate for a number of patients, given their clinical profile, was above 39%. Other individuals in the report appear to not be very sick (Risk of Mortality Levels 1-2) and yet expired. In terms of practical application, the mortality exception report allows hospital staff and physicians to examine case specific data for those mortalities that were not expected or should not have occurred. Staff can prioritize the cases for review and start the process of pulling charts to examine documentation/coding, operational issues, and/or clinical practice issues. For example, upon pulling the charts of a case which shows up on the exception report as a low mortality risk (e.g. femur fracture), the reviewer may determine that there were other mitigating factors, such as heart disease, blood disorder or cancer, that may have played a role in the death of the patient but was not properly documented and/or coded in the patient history. The failure to indicate all relevant information pertinent to the specific case may result in an incorrectly identified Risk of Mortality level. This incorrect information may reflect poorly on the healthcare provider making overall statistics appear as though they are losing more patients to less severe conditions. Once issues are identified, they can be incorporated into internal decision-making for corrective action which may ultimately lead to a more accurate representation of patient conditions from a given healthcare provider.

The Mortality Exception Report is an example of one of the exception reports. Other potential reports may include:
High Costs/Long Stays Exceptions;
One Day and Ambulatory Sensitive Condition Exceptions;
ICU/CCU Exceptions;
AHRQ Patient Safety Indicator Exceptions; and
Hospital Quality Exception cases.
   Each report uses a specific benchmark to generate the exception. Moreover, each report has practical application and is used by clients to improve performance. Healthcare administrators are able to use the exception reports to identify outlying cases, and then determine if there is a need for more accurate clinical annotations to properly identify and quantify risk factors so that a more accurate representation of hospital and/or healthcare provider statistics is made available to the public.

1. A method for improving the performance statistics of a healthcare provider comprising:
a) acquiring data related to the healthcare provider's specific cases;
b) organizing the data into specific category groupings; and
c) identifying exceptional cases that fall within a designated threshold level and presenting those exceptional cases to the healthcare provider for further review.

2. A method as in claim 1 further comprising acquiring the data from a publicly accessible database.

3. A method as in claim 1 further comprising acquiring the data directly from the healthcare provider.

4. A method as in claim 1 further comprising setting a threshold level according to an expected mortality rate for a particular case.

5. A method as in claim 1 further comprising setting a threshold level according to an expected cost of a particular case.

6. A method as in claim 1 further comprising setting the threshold level according to an expected length of stay for a particular case.

7. A method as in claim 1 wherein the step of organizing the data includes organizing data for each physician credentialed by the healthcare provider.

8. A method as in claim 1 further comprising providing feedback to the healthcare provider regarding possible performance and/or documentation issues within the healthcare provider's network.
